(19) United States
(12) Patent Application Publication
(10) Pub. No.: US 2025/0252283 A1
(43) Pub. Date: Aug. 7, 2025

(54) HIERARCHICAL MODE-WISE POOLING

(71) Applicant: INTERNATIONAL BUSINESS MACHINES CORPORATION, ARMONK, NY (US)

(72) Inventors: Kohei Miyaguchi, Tokyo (JP); Ryo Iwaki, Tokyo (JP); Takayuki Osogami, Yamato-shi (JP)

(21) Appl. No.: 18/434,926

(22) Filed: Feb. 7, 2024

(51) Int. Cl. G06N 3/04

(52) U.S. Cl. CPC G06N 3/04

(57) ABSTRACT

An approach is provided for processing received feature vectors whose indices are in an original hierarchical index space. A transformation of each mode of the feature vectors is generated and includes a pooling operation, a transformation operation, and an unpooling operation. The pooling operation aggregates and collapses the feature vectors to produce a coarse-grained feature set having a collapsed index space. The transformation operation transforms the coarse-grained feature set into a transformed feature set that preserves the collapsed index space. The unpooling operation generates a final feature set in the original hierarchical index space by reverting pooling from the transformed feature set. The feature vectors are transformed without any pooling or unpooling to produce an additional set of transformed feature vectors. A summation that preserves the original hierarchical index space is generated by summing the final feature set and the additional set of transformed feature vectors.

### BACKGROUND

The present invention relates to deep learning as a type of machine learning, and more particularly to deep learning with a hierarchically-indexed set of micro-objects.

### SUMMARY

In one embodiment, the present invention provides a computer-implemented method. The method includes receiving feature vectors whose indices are in an original hierarchical index space. The method further includes generating a transformation of each mode of the feature vectors. The transformation includes a pooling operation, a transformation operation, and an unpooling operation. The pooling operation aggregates and collapses the feature vectors so that a coarse-grained feature set having a collapsed index space is produced. The transformation operation transforms the coarse-grained feature set into a transformed feature set that preserves the collapsed index space. The unpooling operation generates a final feature set in the original hierarchical index space by reverting pooling from the transformed feature set. The method further includes transforming the feature vectors without any pooling or unpooling to produce an additional set of transformed feature vectors. The method further includes generating a summation that preserves the original hierarchical index space by summing the final feature set and the additional set of transformed feature vectors.

A computer system and a computer program product corresponding to the above-summarized computer-implemented method are also described herein.

### BRIEF DESCRIPTION OF THE DRAWINGS

FIG. 1 is a block diagram of a system for deep learning using hierarchical mode-wise pooling, in accordance with embodiments of the present invention.

FIG. 2 is a block diagram of modules included in code included in the system of FIG. 1, in accordance with embodiments of the present invention.

FIG. 3 is a flowchart of a process of hierarchical mode-wise pooling, where operations of the flowchart are performed by modules in FIG. 2, in accordance with embodiments of the present invention.

FIG. 4 is an example of a hierarchically-indexed set of micro-objects, where the hierarchical indexing is utilized by the process of FIG. 3, in accordance with embodiments of the present invention.

FIG. 5 is an example of mode-wise pooling utilized in the process of FIG. 3, in accordance with embodiments of the present invention.

FIG. 6 is an example of a mode hierarchy in a text-valued table, where the mode hierarchy is utilized by the process of FIG. 3, in accordance with embodiments of the present invention.

FIG. 7 is an example of a substructure associated with a mode and an aggregation type utilized in the process of FIG. 3, in accordance with embodiments of the present invention.

FIG. 8 is an example of a computation of a hierarchical mode-wise pooling layer utilized in the process of FIG. 3, in accordance with embodiments of the present invention.

### DETAILED DESCRIPTION

### Overview

Conventional techniques for hierarchical message passing for graph neural networks using sequential mode hierarchies and table representation learning methods using flat (i.e., non-hierarchical) mode structures result in machine learning inefficiencies and/or inaccurate machine learning outcomes.

Embodiments of the present invention address the aforementioned unique challenges by providing a hierarchical mode-wise pooling technique that transforms hierarchically-indexed sets of feature vectors for machine learning. Each feature vector represents a micro-object. For example, a database includes a hierarchy of structures from macro-structures to micro-structures. The database consists of interconnected tables, where each table is a matrix of cells, and each cell may contain a text, which is a series of words or tokens. In this case, each token is a micro-object and each token in the database is hierarchically indexed with table, row, column, and token indices.

The hierarchical mode-wise pooling disclosed herein advantageously uses the general structure of an index space with respect to a mode hierarchy. As used herein, a mode refers to an individual index (e.g., a table mode, a row mode, or a token mode). In one embodiment, the hierarchical mode-wise pooling allows the utilization of the entire hierarchy of modes at every level of granularity to achieve an increase in machine learning accuracy and efficiency as compared to the aforementioned conventional techniques. The improvement in efficiency refers to achieving a desired level of machine learning accuracy while requiring a decreased number of samples or a decreased period of time in a training phase of the machine learning.

### Computing Environment

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, computer-readable storage media (also called “mediums”) collectively included in a set of one, or more, storage devices, and that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

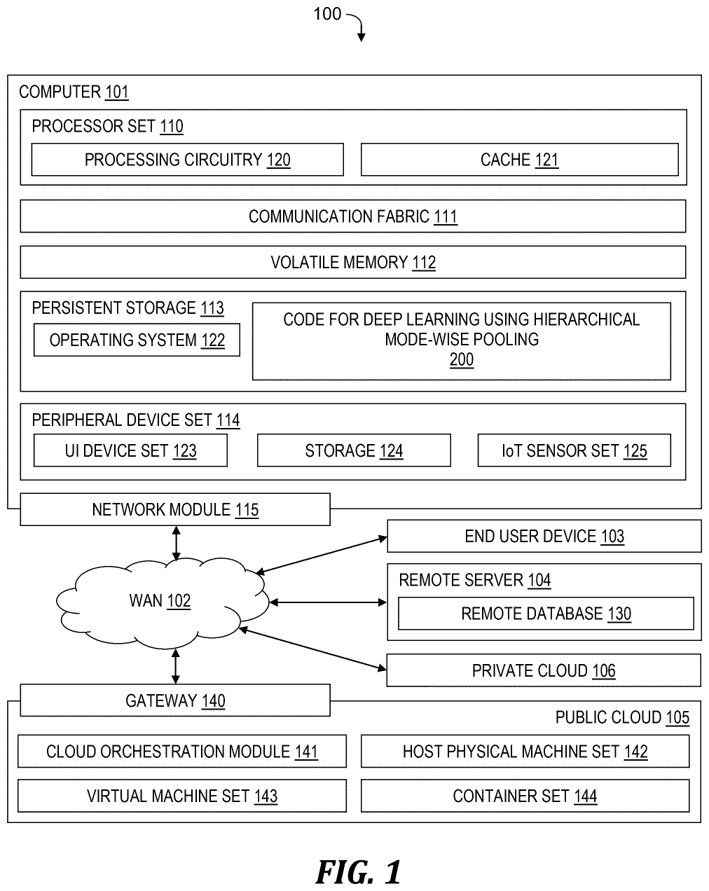

FIG. 1 is a block diagram of a system for deep learning using hierarchical mode-wise pooling, in accordance with embodiments of the present invention. Computing environment 100 contains an example of an environment for the execution of at least some of the computer code involved in performing the inventive methods, such as code 200 for deep learning using hierarchical mode-wise pooling. The aforementioned computer code is also referred to herein as computer-readable code, computer-readable program code, and machine readable code. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to an “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

### System and Process for Hierarchical Mode-Wise Pooling

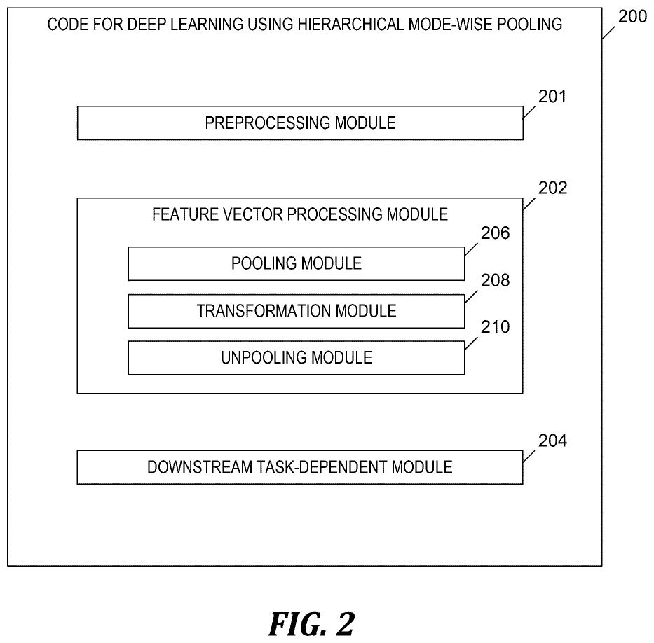

FIG. 2 is a block diagram of modules included in code 200 included in the system 100 of FIG. 1, in accordance with embodiments of the present invention. Code 200 includes a preprocessing module 201, a feature vector processing module 202, and a downstream task-dependent module 204. Feature vector processing module 202 includes a pooling module 206, a transformation module 208, and an unpooling module 210.

Preprocessing module 201 is configured to convert the contents of cells in tables by using tokenization and feature embedding, and provide the converted contents as input to feature vector processing module 202. In one embodiment, a tokenization module (not shown) performs the aforementioned tokenization and a feature embedding module (not shown) performs the aforementioned feature embedding, where the tokenization and feature embedding modules are included in preprocessing module 201. Feature vector processing module 202 is configured to receive and process a set of feature vectors by using a hierarchical mode-wise pooling (HMP) network. The set of feature vectors is a hierarchically-indexed set of feature vectors. The HMP network has a stack of multiple HMP layers. Each HMP layer performs a transformation of the feature vector that preserves an index space, e.g., performs an additional transformation to a preceding transformation that a layer received from an immediately preceding layer in the stack. The processing of the set of feature vectors utilizes pooling module 206, transformation module 208, and unpooling module 210.

Pooling module 206 is configured to pool (i.e., aggregate and collapse) the feature vectors across indices of an aggregation type, which results in a coarse-grained feature set in a collapsed index space. The aggregation type of an index is described in more detail in the discussion of FIG. 7 presented below. A coarse-grained feature set refers to a simplified feature set, e.g., to a changed set that is changed from an initial set to have fewer features than the initial set has. This pooling occurs for all, some, or most of the types of the indices within the hierarchical index space.

Transformation module 208 is configured to transform the aggregated and collapsed feature vectors created by pooling module 206 into a transformed set of feature vectors (also referred to herein as a feature set) that preserves the collapsed index space.

Unpooling module 210 is configured to unpool (i.e., revert pooling from) the transformed feature set that had been created by the transformation module 208. The result of the unpooling is a final feature set having the original hierarchical index space that the set of feature vectors had prior to the processing by pooling module 206. The terminology of “original” does not denote any special requirement other than referring back to this hierarchical index space that the set of feature vectors had upon their receipt and prior to the processing by the pooling module 206.

Feature vector processing module 202 is further configured to compute a sequential composition of the following operations in the following order: the pooling performed by pooling module 206, the transformation performed by transformation module 208, and the unpooling performed by unpooling module 210. Feature vector processing module 202 is further configured to transform, without any pooling or unpooling, the set of feature vectors for an entirety of indices that specify the feature vectors. Feature vector processing module 202 is further configured to generate a transformation of the feature vectors that preserves the original hierarchical index space by summing the aforementioned sequential composition and the transformed feature vectors that were transformed for the entirety of the indices without any pooling or unpooling.

Downstream task-dependent module 204 is configured to utilize the transformations of feature vectors provided by feature vector processing module 202 to complete a downstream task, such as a classification or prediction task for a machine learning system, thereby providing learning outcomes that achieve improvements in learning accuracy and learning efficiency as compared to conventional learning techniques. In one embodiment, the output of an HMP network is a hierarchically-indexed set of feature vectors, and each element of the set (i.e., a feature vector) is used as the input to the downstream task-dependent module 204 independently.

For example, downstream task-dependent module 204 performs a binary classification task on the joinability and unionability of multiple tables, which facilitates the management and organization of data warehouses. Joinability refers to whether a set of multiple tables can be joined as the join operation of a database (i.e., add more features or columns to a table in a horizontal concatenation). Unionability refers to whether a set of multiple columns from multiple tables can be merged to form a single, larger column (i.e., add more rows in a vertical concatenation). For a task of joinability, a 0-1 label is required for each possible pair of tables, which are referred to as the left and right tables. Preprocessing module 201 (e.g., a transformer) converts the contents of each of the cells in a given pair of tables into feature vectors, token by token. The result of the conversion is a set of feature vectors in a hierarchical index space that includes a table mode (i.e., a left table mode or a right table mode), a row mode, a column mode, and a token mode. Based on an induced mode hierarchy, feature vector processing module 202 constructs and applies an HMP network and transforms the set of feature vectors that result from the aforementioned conversion. Because only a single 0-1 label is needed for the pair of tables, feature vector processing module 202 pools and collapses the result of the transformation into a single feature vector, which is subsequently used as the input to downstream task-dependent module 204, which performs the classification using a softmax layer stacked on top of a linear layer. For a task of unionability, a classification is performed similar to the classification described above relative to joinability. A data warehouse utility module (not shown) uses the classification of joinability to automatically list the candidates for a join operation to assist an analysis of the contents of a data warehouse by data scientists. The classification of unionability is used to detect duplications in the tables in a data warehouse.

As another example, downstream task-dependent module 204 determines a prediction of a score of the joinability and unionability described above, where the score is a measure of the confidence of the classification and is determined as a real value, rather than a binary label. Downstream task-dependent module 204 determines the prediction of the score by dropping off the softmax layer from the classification procedure described above.

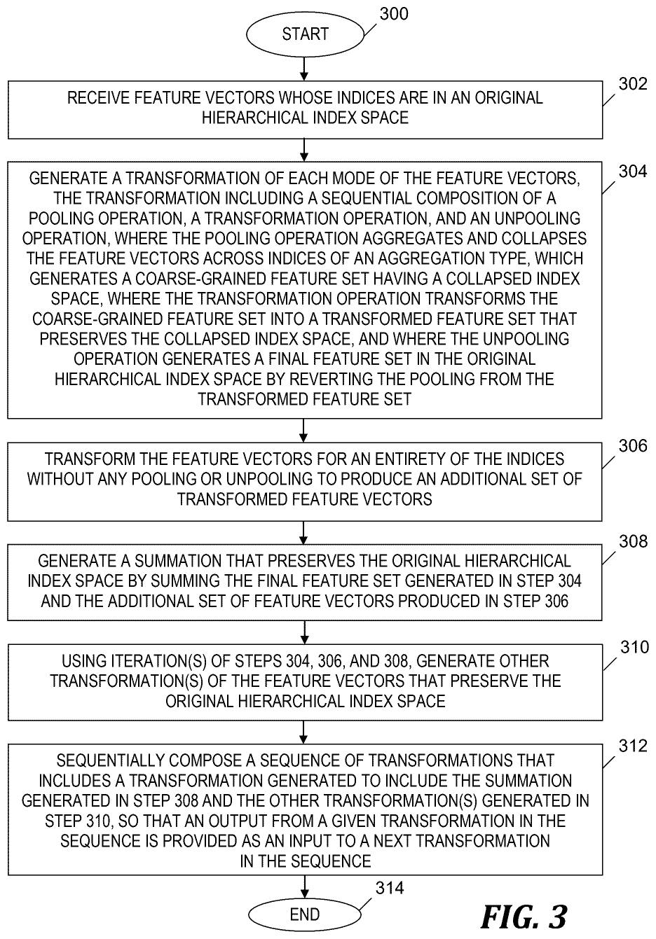

The functionality of the modules included in code 200 is described in more detail in the discussions presented below relative to FIG. 3 through FIG. 8, inclusive.

FIG. 3 is a flowchart of a process of hierarchical mode-wise pooling, where operations of the flowchart are performed by the modules in FIG. 2, in accordance with embodiments of the present invention. The process of FIG. 3 begins at a start node 300. In step 302, feature vector processing module 202 receives feature vectors whose indices are in an original hierarchical index space.

In step 304, feature vector processing module 202 generates a transformation with respect to each mode of the original hierarchical index space, where the transformation includes a sequential composition of a pooling operation, a transformation operation, and an unpooling operation. This reference to “each mode” can also refer to each mode of the received feature vectors. Hereinafter, the sequential composition is also referred to as the mode-m transformation Tₘ(X).

Pooling module 206 performs the pooling operation for the aforementioned sequential composition. The pooling operation aggregates and collapses the feature vectors received in step 302 across indices of an aggregation type, which generates a coarse-grained feature set having a collapsed index space. This pooling occurs for all, some, or most of the types of the indices within the hierarchical index space.

After the pooling operation, transformation module 208 performs the transformation operation for the sequential composition. The transformation operation transforms the aggregated and collapsed feature vectors (i.e., the coarse-grained feature set, which includes the feature vectors resulting from the pooling operation) into a transformed feature set that preserves the collapsed index space resulted from the pooling operation. Hereinafter, the result of the transformation operation in step 304 is also referred to as the transformation Lₘ.

After the transformation operation, unpooling module 210 performs the unpooling operation for the sequential composition. The unpooling operation generates a final feature set in the original hierarchical index space by unpooling the transformed feature set that resulted from the transformation operation. The unpooling includes reverting the pooling from the transformed feature set.

In step 306, feature vector processing module 202 transforms the feature vectors for an entirety of the indices associated with the original hierarchical index space, where the transformation of the feature vectors is performed without any pooling or unpooling. The transforming of the feature vectors in step 306 produces an additional set of transformed feature vectors. The entirety of the indices associated with the original hierarchical index space is also referred to herein as simply “the entirety of the indices” or “all the indices.” Hereinafter, this alternative transformation of the feature vectors in step 306 is also referred to as the transformation L₀(X).

In step 308, feature vector processing module 202 generates a summation that preserves the original hierarchical index space by summing the final feature set generated in step 304 and the additional set of transformed feature vectors produced in step 306.

In step 310, feature vector processing module 202 generates other transformation(s) of the feature vectors that preserve the original hierarchical index space by using iteration(s) of steps 304, 306, and 308.

In step 312, feature vector processing module 202 sequentially composes a sequence of transformations that includes a transformation generated to include the summation generated in a first performance of step 308 and the other transformation(s) generated in step 310, so that an output from a given transformation in the sequence is provided as an input to a next transformation in the sequence. The aforementioned given transformation is in an i-th position in the sequence and the aforementioned next transformation is in an (i+1)-th position in the sequence, where the sequence includes n transformations, where n is an integer greater than or equal to two, and where i is an integer greater than or equal to one and less than n.

Following step 312, the process of FIG. 3 ends at an end node 314.

Although not shown in FIG. 3, downstream task-dependent module 204 uses the sequential composition of transformations in step 312 to complete a classification or prediction task for a machine learning system.

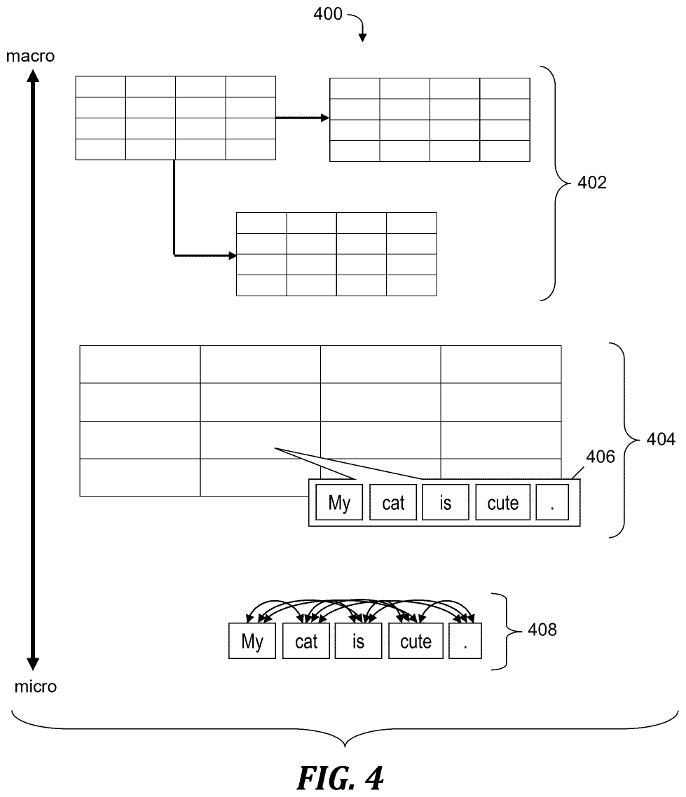

FIG. 4 is an example 400 of a hierarchically-indexed set of micro-objects, where the hierarchical indexing is utilized by the process of FIG. 3, in accordance with embodiments of the present invention. In one embodiment, the hierarchical mode-wise pooling disclosed herein facilitates machine learning with a hierarchically-indexed set of micro-objects. In example 400, a database has a hierarchy of structures from macro to micro-sized structures. The database includes interconnected tables having an inter-table structure 402. Each table includes an inter-cell structure 404. Each table is a matrix of cells, and each cell may contain a text, which is a series of words or tokens. Inter-cell structure 404 includes a series of tokens 406, which has an inter-token structure 408. Each token (i.e., micro-object) in the database is hierarchically indexed with table, row, column, and token indices. In one embodiment, the hierarchical mode-wise pooling that provides the transformation of feature vectors that preserves an original hierarchical index space in the process of FIG. 3 uses the structures included in example 400 to achieve an improvement in machine learning efficiency.

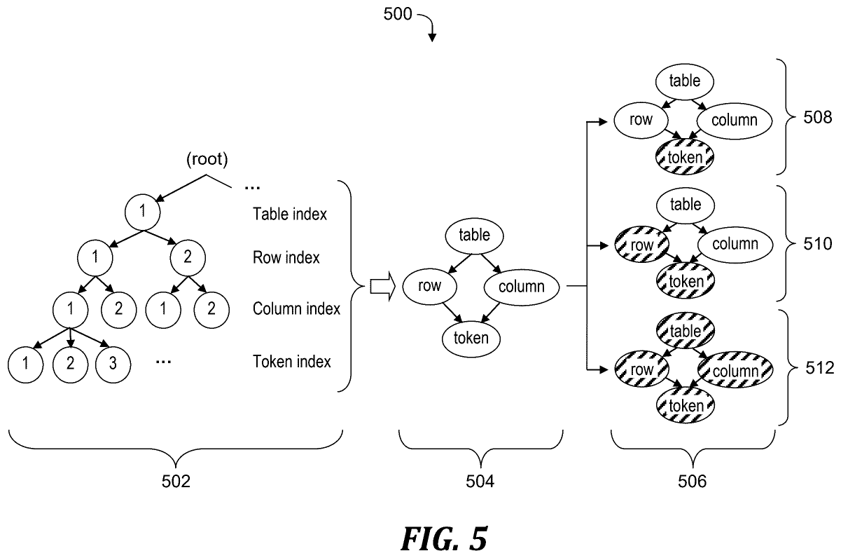

FIG. 5 is an example 500 of mode-wise pooling utilized in the process of FIG. 3, in accordance with embodiments of the present invention. Example 500 includes a hierarchically-indexed set 502 that includes table, row, column, and token indices. Code for deep learning using hierarchical mode-wise pooling 200 extracts a mode hierarchy 504 from hierarchically-indexed set 502 to capture the dependencies among the indices. Each mode in the mode hierarchy 504 refers to an individual index, such as a row mode referring to the row indices and a token mode referring to token indices. A mode-wise pooling 506 transforms the hierarchically-indexed set 502 by using mode hierarchy 504. Mode-wise pooling 506 includes a token-wise pooling 508, a row-wise pooling 510, and a table-wise pooling 512. In example 500, a mode-wise pooling for a particular mode m means pooling applied to the indices of mode m and to the indices of any mode that directly or indirectly depends on mode m, where the dependencies are specified by mode hierarchy 504 The shaded ovals in token-wise pooling 508, row-wise pooling 510, and table-wise pooling 512 specify the indices across which each particular pooling is performed.

The hierarchical mode-wise pooling allows for the utilization of the entire hierarchy of mode in mode hierarchy 504 at every level of granularity.

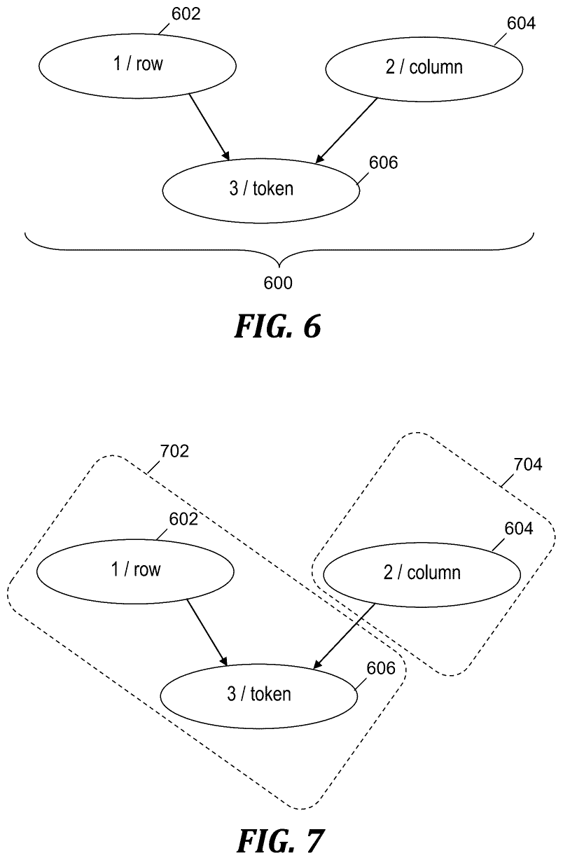

FIG. 6 is an example 600 of a mode hierarchy in a text-valued table, where the mode hierarchy is utilized by the process of FIG. 3, in accordance with embodiments of the present invention. In example 600, a table has text entries and every token in the table is indexed with λ=(r, c, t), where r is the row-mode index, c is the column-mode index, and t is the token-mode index representing the position within each cell of the table. These modes are individually referred to as the mode 1, 2, 3 (i.e., mode 602, mode 604, and mode 606, respectively) of the table.

The modes are subject to hierarchical dependencies, as specified in the mode hierarchy in FIG. 6. In example 600, the token mode is a substructure of the row and column modes, because the range and semantics of t depends on (r, c).

FIG. 7 is an example of a substructure 702 (i.e., a substructure associated with a mode 1) and an aggregation type 704 (i.e., the set of mode(s) in a mode hierarchy that do not include the substructure associated with mode 1) utilized in the process of FIG. 3, in accordance with embodiments of the present invention. An index set having the hierarchical mode dependencies included in example 600 in FIG. 6 is referred to as a hierarchical index space Λ.

The mode hierarchy of the hierarchical index space Λ defines a directed acyclic graph (DAG), where each vertex uniquely represents a mode, and each edge (u, v) indicates that the semantics of mode v depends on the index of mode u. The descendant(s) of mode m and m itself in a mode hierarchy are referred to collectively as the substructure associated with mode m, denoted by sub(m). Therefore, substructure 702, which is sub(m), where m=1, is the portion of the mode hierarchy in example 600 that includes the descendant of mode 1 (i.e., the token mode, which is the descendant of the row mode) and mode 1 itself (i.e., the row mode).

The coarse-graining of index λ∈Θ that collapses sub(m) is referred to as the aggregation type of λ, denoted by [λ]ₘ:=(λ_{m′}:m′∉sub(m)). Furthermore, the space of aggregation types is denoted by [Λ]ₘ:=(τₘ(λ):λ∈Λ). Therefore, the aggregation type of A includes the portion of the mode hierarchy that is not included in the substructure associated with mode m. The aggregation type of A identifies the grouping in the operations of a mode m. Each element in the input of an HMP layer is grouped with respect to the aggregation type and processed separately in the pooling, transformation, and unpooling operations of the substructure associated with mode m. Furthermore, aggregation type 704 is the portion of the mode hierarchy in example 600 that is not included in the substructure associated with mode 1. That is, aggregation type 704 includes only the column mode, which is the portion of the mode hierarchy that is not included in the substructure associated with mode 1 (i.e., aggregation type 704 is the portion of the mode hierarchy not included in the substructure 702).

Substructure 702 (i.e., the substructure associated with mode 1) specifies that mode 602 (i.e., the row mode) and mode 606 (i.e., the token mode) are to be pooled by pooling module 206 in step 304. Aggregation type 704 specifies that mode 604 (i.e., the column mode) is not to be pooled by pooling module 206.

### Technical Details of Hierarchical Mode-Wise Pooling

In one embodiment, the hierarchical mode-wise pooling process in FIG. 3 utilizes an HMP network that processes a set of feature vectors X:={x_{λ}:λ∈Λ}, x_{λ}∈ [symbol] , with an original hierarchical index space denoted by Λ. Feature vector processing module 202 receives the set of feature vectors X in step 302.

The HMP network includes a stack of multiple HMP layers intercalated with standard constructs of a deep neural network, such as activation functions, normalization layers, and skip connections. The multiple HMP layers are sequentially composed to form the HMP network, which means that an output of a given HMP layer in a sequence is fed into the input of a next HMP layer in the sequence. In one embodiment, the sequential composition in step 312 includes the sequential composition of HMP layers that forms the HMP network.

Each HMP layer f is also a transformation of feature vectors preserving the index space Λ. HMP layer f consists of the sum of a transformation L₀(X) and multiple mode-wise transformations Tₘ(X) for m∈ [symbol] , which is computed by equation (1) presented below.

$$f ( X ) := {L}_{0} ( X ) + {\sum }_{m ∈ ℳ} {T}_{m} ( X ) , \qquad ( 1 )$$

where [symbol] is a set of modes of interest.

Each mode-m transformation in step 304 is composed of the sequential application of pooling Pₘ, transformation Lₘ, and unpooling Pₘ*, which is computer by equation (2) presented below.

$${T}_{m} ( X ) := {P}_{m}^{*} ( {L}_{m} ( {P}_{m} ( X ) ) ) \qquad ( 2 )$$

Pooling Pₘ pools features across the indices of the same type [λ]ₘ, which generates a coarse-grained feature set Z:={z_{τ}:τ∈[Λ]ₘ}, z_{τ}∈ [symbol] ^{D}. Pooling Pₘ may be implemented by a pooling operation selected from the group consisting of mean pooling, sum pooling, and max pooling ϕₘ^{agg}, such that z_{τ}:=ϕₘ^{agg}({x_{λ}:[λ]ₘ=τ}). In one embodiment, pooling Pₘ pools more than one mode or pools exactly one mode that is not a leaf in the mode hierarchy.

Transformation Lₘ transforms the pooled feature set from Z to \tilde{Z}{\tilde{z}_{τ}:τ∈[Λ]ₘ}, \tilde{z}_{τ}∈ [symbol] ^{\tilde{D}}, which preserves the collapsed index space that resulted from pooling Pₘ. In one embodiment, \tilde{D} is a value specified by a user. Transformation Lₘ may be implemented by a linear mapping, such that \tilde{z}_{\tilde{τ}}:=Σ_{τ∈N}_{ₘ}_{(\tilde{τ})}W_{\tilde{τ}τ}^{(m)}z_{τ}, where each W_{\tilde{τ}τ}^{(m)}∈ [symbol] ^{\tilde{D}×D} is a learnable matrix and Nₘ(\tilde{τ}) is a suitable neighbor of type \tilde{τ}.

For example, N(\tilde{τ}) may include the types i, only differing from i at the leaf nodes in the mode hierarchy of the type space [Λ]ₘ (i.e., the hierarchy after collapsing sub(m)). Unpooling Pₘ* reverts pooling from the transformed features Z′ to a final feature set Y:={y_{λ}:λ∈Λ}, y_{λ}∈ [symbol] ^{\tilde{D}}, which has the original hierarchical index space Λ. Unpooling Pₘ* may be implemented by broadcasting such that y_{λ}:z_{[λ]}_{_{M}}′.

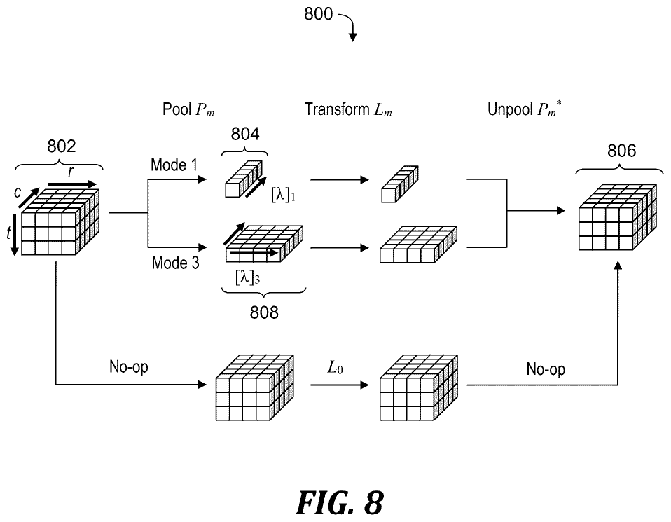

FIG. 8 is an example 800 of a computation of a hierarchical mode-wise pooling layer utilized in the process of FIG. 3, in accordance with embodiments of the present invention. Example 800 illustrates a computation of an HMP layer with respect to [symbol] ={1,3} from the mode hierarchy shown in FIG. 6. The types of indices in example 800 are listed below:
[λ]₁=[r,c,t]₁:=c,
[λ]₂=[r,c,t]₂:=r,
[λ]₃=[r,c,t]₃:=(r,c)

Example 800 includes an input feature set, which is a three-dimensionally indexed set of feature vectors, represented by a cube structure 802 that includes multiple smaller boxes, where the height of the cube structure 802 corresponds to the token index, the depth corresponds to the column index, and the width corresponds to the row index. Each box within cube structure 802 corresponds to a feature vector.

In the mode-wise pooling for Mode 1 in example 800, the pooling causes a collapse of the row mode along the horizontal axis of the cube structure 802 and a collapse of the token mode along the vertical axis of the cube structure 802, leaving only the one-dimensional structure 804 (i.e., the column mode) along the depth direction of the cube structure 802. After the pooling, the transformation is applied to the column mode in one-dimensional structure 804, which retains the one-dimensional index space. After the transformation, the unpooling is applied to restore the index space to the original three-dimensional index space (i.e., expands the one-dimensional structure 804 into a three-dimensional cube structure), as shown by a three-dimensional cube structure 806 representing an HMP layer.

In the mode-wise pooling for Mode 3 in example 800, the pooling collapses only the token mode along the vertical axis of cube structure 802, which leaves a two-dimensional structure 808 (i.e., the row and column modes). The transformation retains the two-dimensional structure 808 and the unpooling restores the index space to the original three-dimensional index space, as shown by the three-dimensional cube structure 806 representing an HMP layer.

In example 800, the path labeled “No-op” indicates that pooling and unpooling operations are not being applied and the transformation L₀ operates on the same index space of the original input feature set and does not change the index space.

The descriptions of the various embodiments of the present invention have been presented herein for purposes of illustration but are not intended to be exhaustive or limited to the embodiments disclosed. Many modifications and variations will be apparent to those or ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
receiving feature vectors whose indices are in an original hierarchical index space;
generating a transformation of each mode of the feature vectors, the transformation including a pooling operation, a transformation operation, and an unpooling operation, wherein the pooling operation aggregates and collapses the feature vectors so that a coarse-grained feature set having a collapsed index space is produced, wherein the transformation operation transforms the coarse-grained feature set into a transformed feature set that preserves the collapsed index space, and wherein the unpooling operation generates a final feature set in the original hierarchical index space by reverting pooling from the transformed feature set;
transforming the feature vectors without any pooling or unpooling to produce an additional set of transformed feature vectors; and
generating a summation that preserves the original hierarchical index space by summing the final feature set and the additional set of transformed feature vectors.

2. The computer-implemented method of claim 1, further comprising:
generating a transformation of the feature vectors to include the generated summation that preserves the original hierarchical index space;
generating one or more other transformations of the feature vectors that preserve the original hierarchical space; and
sequentially composing a sequence of transformations that includes the generated transformation of the feature vectors and the generated one or more other transformations of the feature vectors, so that an output from a given transformation in the sequence is provided as an input to a next transformation in the sequence.

3. The computer-implemented method of claim 1, further comprising:
processing the feature vectors by using a hierarchical mode-wise pooling (HMP) network that includes a stack of multiple HMP layers intercalated with constructs of a deep neural network, each HMP layer being a given transformation of the feature vectors that includes (i) the summation that preserves the original hierarchical index space or (ii) another summation that preserves the original hierarchical index space and is generated by summing another final feature set and another additional set of transformed feature vectors.

4. The computer-implemented method of claim 1, wherein the feature vectors are X:={x_{λ}:λ∈Λ}, x_{λ}∈ [symbol] ^{D}, wherein the original hierarchical index space is Λ, wherein the computer-implemented method further comprises computing f(X):=L₀(X)+ [symbol] Tₘ(X), wherein f is a transformation of the feature vectors X preserving the original hierarchical index space Λ, wherein L₀(X) is a transformation of the feature vectors X without pooling, wherein a mode is denoted by m, wherein Mis a set [symbol] modes of interest, and wherein Tₘ(X) is a mode-wise transformation for the mode m.

5. The computer-implemented method of claim 4, further comprising computing the mode-wise transformation for the mode m by computing Tₘ(X):=Pₘ*(Lₘ(Pₘ(X))), wherein Pₘ is the pooling operation, wherein the coarse-grained feature set resulting from the pooling operation is Z:={z_{τ}:τ∈[Λ]ₘ}, z_{τ}∈ [symbol] ^{D}, wherein [Λ]ₘ is a space of aggregation types and is computed by [Λ]ₘ:={τₘ(λ):λ∈Λ}, wherein Lₘ is the transformation operation, wherein the transformed feature set is \tilde{Z}:={\tilde{z}_{τ}:τ∈[Λ]ₘ}, \tilde{z}_{τ}∈ [symbol] ^{\tilde{D}}, wherein D is a value specified by a user, wherein Pₘ* is the unpooling operation, and wherein the final feature set is Y:={y_{λ}:λ∈Λ}, y_{λ}∈ [symbol] ^{\tilde{D}}.

6. The computer-implemented method of claim 5, wherein the pooling operation is selected from the group consisting of mean pooling, sum pooling, and max pooling ϕₘ^{agg}, such that z_{τ}:=ϕₘ^{agg}({x_{λ}:[λ]ₘ=τ}), wherein [λ]ₘ is an aggregation type of λ and is computed by [λ]ₘ:=(λ_{m′}:m′∉sub(m)), and wherein sub(m) is a substructure associated with the mode m, the substructure being the mode m and the descendants of the mode m.

7. The computer-implemented method of claim 5, wherein the transformation operation is a linear mapping, such that \tilde{z}_{\tilde{τ}}=Σ_{τ∈N}_{ₘ}^{(\tilde{τ})}W_{\tilde{τ}τ}^{(m)}z_{τ}, wherein each W_{\tilde{τ}τ}^{(m)}∈ [symbol] ^{\tilde{D}×D} is a learnable matrix and Nₘ(\tilde{τ}) is a suitable neighbor of type \tilde{τ}.

8. The computer-implemented method of claim 1, wherein the unpooling operation is implemented by broadcasting such that y_{λ}:=z_{[λ]}_{ₘ}′.

9. The computer-implemented method of claim 1, wherein a mode is denoted by m, and wherein the pooling operation further aggregates and collapses the feature vectors across indices of an aggregation type, which includes elements of a mode hierarchy except for the mode m in the mode hierarchy and descendants of the mode m in the mode hierarchy.

10. The computer-implemented method of claim 1, wherein the generating the transformation of each mode includes computing a sequential composition of the pooling operation, the transformation operation, and the unpooling operation.

11. The computer-implemented method of claim 1, wherein the transforming the feature vectors without any pooling or unpooling includes transforming the feature vectors for an entirety of the indices.

12. A computer system comprising:
a processor set;
a set of one or more computer-readable storage media; and
program instructions, collectively stored in the set of one or more computer-readable storage media, for causing the processor set to perform the following computer operations:
receive feature vectors whose indices are in an original hierarchical index space;
generate a transformation of each mode of the feature vectors, the transformation including a pooling operation, a transformation operation, and an unpooling operation, wherein the pooling operation aggregates and collapses the feature vectors so that a coarse-grained feature set having a collapsed index space is produced, wherein the transformation operation transforms the coarse-grained feature set into a transformed feature set that preserves the collapsed index space, and wherein the unpooling operation generates a final feature set in the original hierarchical index space by reverting pooling from the transformed feature set;
transform the feature vectors without any pooling or unpooling to produce an additional set of transformed feature vectors; and
generate a summation that preserves the original hierarchical index space by summing the final feature set and the additional set of transformed feature vectors.

13. The computer system of claim 12, wherein the program instructions cause the processor set to perform the following additional computer operations:
generate a transformation of the feature vectors to include the generated summation that preserves the original hierarchical index space;
generate one or more other transformations of the feature vectors that preserve the original hierarchical space; and
sequentially compose a sequence of transformations that includes the generated transformation of the feature vectors and the generated one or more other transformations of the feature vectors, so that an output from a given transformation in the sequence is provided as an input to a next transformation in the sequence.

14. The computer system of claim 12, wherein the program instructions cause the processor set to perform the following additional computer operation:
process the feature vectors by using a hierarchical mode-wise pooling (HMP) network that includes a stack of multiple HMP layers intercalated with constructs of a deep neural network, each HMP layer being a given transformation of the feature vectors that includes (i) the summation that preserves the original hierarchical index space or (ii) another summation that preserves the original hierarchical index space and is generated by summing another final feature set and another additional set of transformed feature vectors.

15. The computer system of claim 12, wherein the feature vectors are X:={x_{λ}:λ∈Λ},x_{λ}∈ [symbol] ^{D}, wherein the original hierarchical index space is A, wherein the program instructions cause the processor set to perform the following additional computer operation: compute f(X):=L₀(X)+ [symbol] Tₘ(X), wherein f is a transformation of the feature vectors X preserving the original hierarchical index space Λ, wherein L₀(X) is a transformation of the feature vectors X without pooling, wherein a mode is denoted by m, wherein Mis a set of modes of interest, and wherein Tₘ(X) is a mode-wise transformation for the mode m.

16. The computer system of claim 15, wherein the program instructions cause the processor set to perform the following additional computer operation: compute the mode-wise transformation for the mode m by computing Tₘ(X):=Pₘ*(Lₘ(Pₘ(X))), wherein Pₘ is the pooling operation, wherein the coarse-grained feature set resulting from the pooling operation is Z:={z_{τ}:τ∈[Λ]ₘ},z_{τ}∈ [symbol] ^{D}, wherein [Λ]ₘ is a space of aggregation types and is computed by [Λ]ₘ:={τₘ(λ):λ∈Λ}, wherein Lₘ is the transformation operation, wherein the transformed feature set is \tilde{Z}:={\tilde{z}_{τ}:τ∈[Λ]ₘ}, \tilde{z}_{τ}∈ [symbol] ^{\tilde{D}}, wherein D is a value specified by a user, wherein Pₘ* is the unpooling operation, and wherein the final feature set is Y:={y_{λ}:λ∈Λ},y_{λ}∈ [symbol] ^{\tilde{D}}.

17. A computer program product comprising:
a set of one or more computer-readable storage media; and
program instructions, collectively stored in the set of one or more computer-readable storage media, for causing a processor set to perform the following computer operations:
receive feature vectors whose indices are in an original hierarchical index space;
generate a transformation of each mode of the feature vectors, the transformation including a pooling operation, a transformation operation, and an unpooling operation, wherein the pooling operation aggregates and collapses the feature vectors so that a coarse-grained feature set having a collapsed index space is produced, wherein the transformation operation transforms the coarse-grained feature set into a transformed feature set that preserves the collapsed index space, and wherein the unpooling operation generates a final feature set in the original hierarchical index space by reverting pooling from the transformed feature set;
transform the feature vectors without any pooling or unpooling to produce an additional set of transformed feature vectors; and
generate a summation that preserves the original hierarchical index space by summing the final feature set and the additional set of transformed feature vectors.

18. The computer program product of claim 17, wherein the program instructions cause the processor set to perform the following additional computer operations:
generate a transformation of the feature vectors to include the generated summation that preserves the original hierarchical index space;
generate one or more other transformations of the feature vectors that preserve the original hierarchical space; and
sequentially compose a sequence of transformations that includes the generated transformation of the feature vectors and the generated one or more other transformations of the feature vectors, so that an output from a given transformation in the sequence is provided as an input to a next transformation in the sequence.

19. The computer program product of claim 17, wherein the program instructions cause the processor set to perform the following additional computer operation:
process the feature vectors by using a hierarchical mode-wise pooling (HMP) network that includes a stack of multiple HMP layers intercalated with constructs of a deep neural network, each HMP layer being a given transformation of the feature vectors that includes (i) the summation that preserves the original hierarchical index space or (ii) another summation that preserves the original hierarchical index space and is generated by summing another final feature set and another additional set of transformed feature vectors.

20. The computer program product of claim 17, wherein the feature vectors are X:={x_{λ}:λ∈Λ},x_{λ}∈ [symbol] ^{D}, wherein the original hierarchical index space is A, wherein the program instructions cause the processor set to perform the following additional computer operation: compute f(X):=L₀(X)+ [symbol] Tₘ(X), wherein f is a transformation of the feature vectors X preserving the original hierarchical index space Λ, wherein L₀(X) is a transformation of the feature vectors X without pooling, wherein a mode is denoted by m, wherein [symbol] is a set of modes of interest, and wherein Tₘ(X) is a mode-wise transformation for the mode m.
